(19) United States
(12) Patent Application Publication
(10) Pub. No.: US 2015/0100581 A1
(43) Pub. Date: Apr. 9, 2015

(54) METHOD AND SYSTEM FOR PROVIDING ASSISTANCE TO A RESPONDER

(71) Applicant: ChaCha Search, Inc, Carmel, IN (US)

(72) Inventor: Eugene M. O'Donnell, Fishers, IN (US)

(21) Appl. No.: 14/508,891

(22) Filed: Oct. 7, 2014

Related U.S. Application Data
(60) Provisional application No. 61/888,366, filed on Oct. 8, 2013.

(51) Int. Cl. G06F 17/30; H04L 29/08

(52) U.S. Cl. CPC G06F 17/3053; H04L 67/10; G06F 17/30598
USPC 707/737

(57) ABSTRACT

A method and system are described for providing assistance to a person responding to a request for subjective information. A type which may be used to provide information to a responder is associated with a request based on content of the request and user information. A user interface and suggested responses are provided to a responder based on a type and a subject matter of the request which taken together with the systems and interfaces provide enhanced communications between users while improving network efficiency.

### BACKGROUND

1. Field of the Invention

The present invention is related to providing search results and facilitating interactions between persons responding to a request and persons submitting a request.

2. Description of the Related Art

In a system wherein users may submit questions and receive responses the queries may be widely varying. Questions may be presented on any topic, and may require an answer which could be provided by almost any person while other questions may require factual data, research and expertise to respond appropriately.

A portion of queries received may be seeking subjective or opinion based answers. A response to an opinion query may not require specific knowledge, but may require a polite or appropriate answer. For example, it may require more effort by a responder to compose an answer to an opinion query than it does to determine a suitable answer due to the need to provide a complete sentence using a small screen device such as a cellphone. Some responders may not wish to respond to opinion-based requests, while other may prefer not to respond to factual requests.

Opinion based responses may be more likely to be offensive to a person submitting a request. For example, a responder may disagree with an expectation of a user, or may provide an answer which is intended to be humorous, but is instead found to be offensive. For example, a user may request a joke. A responder may not know a joke, or might have a different sense of humor than the requester. A request for an opinion might be answered by a one or two word response. While such a response is desirable for a responder, the experience for the asker or user may be unsatisfactory.

Because of these and other problems a method and system for assisting a responder to respond to opinion based requests would be greatly appreciated.

### SUMMARY

A system is implemented whereby a user may submit a request for information or query and receive an answer. A request may be received by a search system which may store the request, and determine how to respond to a request. A server associated with a search system may correct errors in, identify portions of, categorize, and/or associate various metadata with a request. A search system may determine whether an automated response is available for a request. A search system may determine whether a request is seeking subjective or objective information.

A search system may determine whether a request is to be distributed to a human assistant or “guide”. A guide may be a user. A guide may be associated with information which may be used to direct a request. For example, a guide or responder may select or be associated with a keyword, category, topic, named entity, geographic, demographic, affiliation, task type, etc., information which may be used to determine whether a request will be presented to a responder. A rating and/or ranking of a request for a responder and/or a responder for a request may be used to determine whether a responder will be notified of a request.

A toolset may be provided to a responder device. An interface provided to a responder device may be determined based on metadata associated with a request. A type associated with a request may determine response options presented to a responder. A responder may be able to select requests which are ranked based on metadata. If a responder is interested to answer opinion requests regarding a topic or category, requests which are highly ranked for being opinion requests regarding a category may be presented for a responder to review. A responder may indicate that a request is correctly or incorrectly classified, which may influence future classification of requests. A toolset may be determined based on an action of a responder.

A toolset provided to a responder may include features for facilitating a rapid response. For example if a request is seeking a prediction of an event, a responder interface may include a control which will generate a pre-determined response based on a random number and/or information of the responder. Likewise a number of automatically generated sentences which may be used to respond to a request may be presented to a responder, who may elect to send a response by activating a control associated with an automatically generated sentence. If a request is seeking humor, riddles, etc. a control which may provide possible responses may be presented to a responder. Responses may be selected based on information of a responder. A responder may be able to scroll through options for responses if a suitable response is not presented. Historical requests and/or responses of a user may be presented to a responder.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for responders.

FIG. 5 illustrates a database for resources.

FIG. 6 is a flowchart of processing a query.

FIG. 7 is a flowchart of processing a subjective query.

FIG. 8 is a flowchart of selecting a user interface.

FIG. 9 is a Graphical User Interface (GUI) for finding questions of interest.

FIG. 10 is a GUI for query entry of an unknowable query.

FIG. 11 is a GUI for responding to an unknowable query.

FIG. 12 is a GUI for query entry of discussion query.

FIG. 13 is a GUI for responding to discussion query.

FIG. 14 is a GUI for query entry of social query.

FIG. 15 is a GUI for responding to social query.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server receiving the query, a database storing information of queries, search results, searchers, responders, users, resources and other information, a guide system receiving a query and providing a search result, and a resource system providing potential answers.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, an application or “app”, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query, associate a query with metadata, and/or determine a type of processing. Results of automated processing such as categorization, spelling correction, named entity extraction, location association, etc. may be stored for later use. Automated processing may include selection of a response based on natural language processing of a request and/or submission of a request to an automated resource selected based on a request.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to the query or “searcher”. A searcher may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services. A resource may include an information repository such as those associated with FaceBook, Twitter, eBay, Amazon, etc. which may have various levels of access rights.

As used herein, a “request” means a request for information, products, and/or services. A request or search request or query or question may include various types of media, and may be provided by any user system which may establish communication with a server and/or other devices associated with a search service. A request may be referred to as a “search request”, “search query”, “question” or “query”.

A “user” is a person who submits a request and may receive any type of information responsive to a request. A user may be any person or entity. A “guide” is a person who assists in processing a request. A guide may be referred to as a “provider”, “searcher”, “human searcher”, “human assistant”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

A human assistant such as an expediter may select a search result associated with a previous query and/or an automated resource. A search result selected by a human assistant may be indicated as a sponsored result and/or an organic result. A human assistant may be presented with sponsored results, organic results, and/or a mixture of organic and sponsored results. An expediter may be associated with a sponsor, and may be presented with sponsored results associated with the sponsor. A “sponsored result” may be any media which is presented responsive to a request which has been provided by a party interested in influencing whether a result is presented. An “organic” result may be any result which is produced based solely on a probability that the response will meet a user's request without regard to influence by a provider of a result.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop, tablet or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, a resource and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different or the same user device.

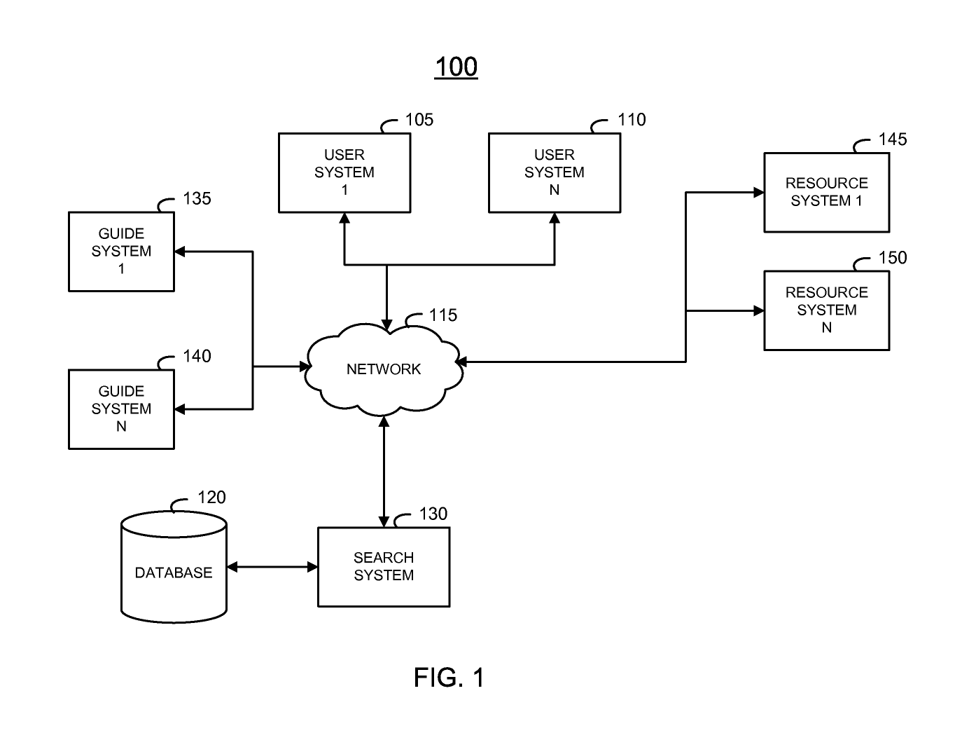

As illustrated in FIG. 1, system 100 includes user systems 105, 110, a network 115 such as the Internet, a search system 130, a database 120, which may comprise various records, guide systems 135, 140, and resource systems 145, 150.

While only a few systems associated with a user, a resource, and a guide are depicted in FIG. 1 it is within the scope of the disclosure for multiple systems for a user, resource and guide to be utilized. In particular it is envisioned that many user, resource and guide systems may be implemented. The search system 130 may be a composed of many components as described further herein.

Any user system (e.g. the user system 105) can be used, to submit a request to the search system 130 and/or receive a result and/or other information. Any user system may receive a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, and the resource systems 145, 150 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140 and the resource systems 145, 150. For example, a request can be transmitted from the user system 105 to the search system 130, which may provide information obtained from the database 120, which may include an advertisement provided by the resource system 150 to the user system 105. Similarly, a search result from a searcher operating the guide system 135 and/or the resource system 145 might be routed to the search system 130, which might process the search result, formulate a response and provide a message to the user system 105. Any type of communication between users, resources and/or guides may be mediated and/or facilitated by the search system 130 and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, the resource systems 145, 150 and the search system 130 may include equipment, software, systems and personnel required to send and/or receive messages between a user system 105, 110, the guide systems 135, 140, the resource systems 145, 150 and/or the search system 130 using the network 115. The database 120 includes information which may allow the search system 130 to establish communication between any or all of the elements of the system 100.

A user system, a guide system, a resource system and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, sponsor systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, an app ID, and/or any other identifier which may be used to associate information with a user. Multiple identifiers of a user may be associated with each other. Using information of communication services associated with a user, a communication session may be established between a user system such as the user system 105 and a resource system, a guide system and/or the search system 130. Information such as a keyword, a category, a user profile, a request, a result, etc., may be associated with a user. A user may be required to provide profile information to the search system 130. A user may elect to receive requests from the search system 130. Parameters and/or attributes may be associated with a user as will be further described herein below. Information of a user may be stored in the database 120.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system and/or the search system 130.

When a guide registers with the search system 130 the guide may be associated with one or more keywords, categories, profiles, and/or other information. Information associated with a guide may be stored in the database 120 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a guide.

A resource may be required to register with the search system 130. As part of a registration process, at least one communication method is associated with a resource. In at least one embodiment, a resource may register with the search system 130 and establish a username and password which are associated with the resource. A resource may login to the search system 130 using a web browser functionality of the resource system 145 in order to communicate with the search system 130. Multiple communication services may be associated with a resource and may allow a communication session to be established between a resource system such as the resource system 145 and a user system, a guide system, and/or the search system 130. Multiple identifiers of a resource may be associated with each other. Information such as IM credentials, an email address, a phone number, a URL, a username, etc., of a resource may be identified which may allow the search system 130 to establish a communication session between a resource system and a user system, a guide system and/or the search system 130.

When a resource is registered with and/or detected by the search system 130 the resource may be associated with one or more keywords, categories, profiles, and/or other information. Information associated with a resource may be stored in the database 120 and may be used for various purposes. Information associated with a resource may be used to rank requests, resources, results, advertisements, guides and/or other information which may be presented to the resource. In at least one embodiment, payment information is associated with a resource. A resource may provide payment information which may be used to compensate the search system 130 for advertisements and/or sponsored answers provided to a user. A resource may designate a guide associated with a resource, and may provide registration information associated with the guide. A resource may designate conditions for accessing a resource.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

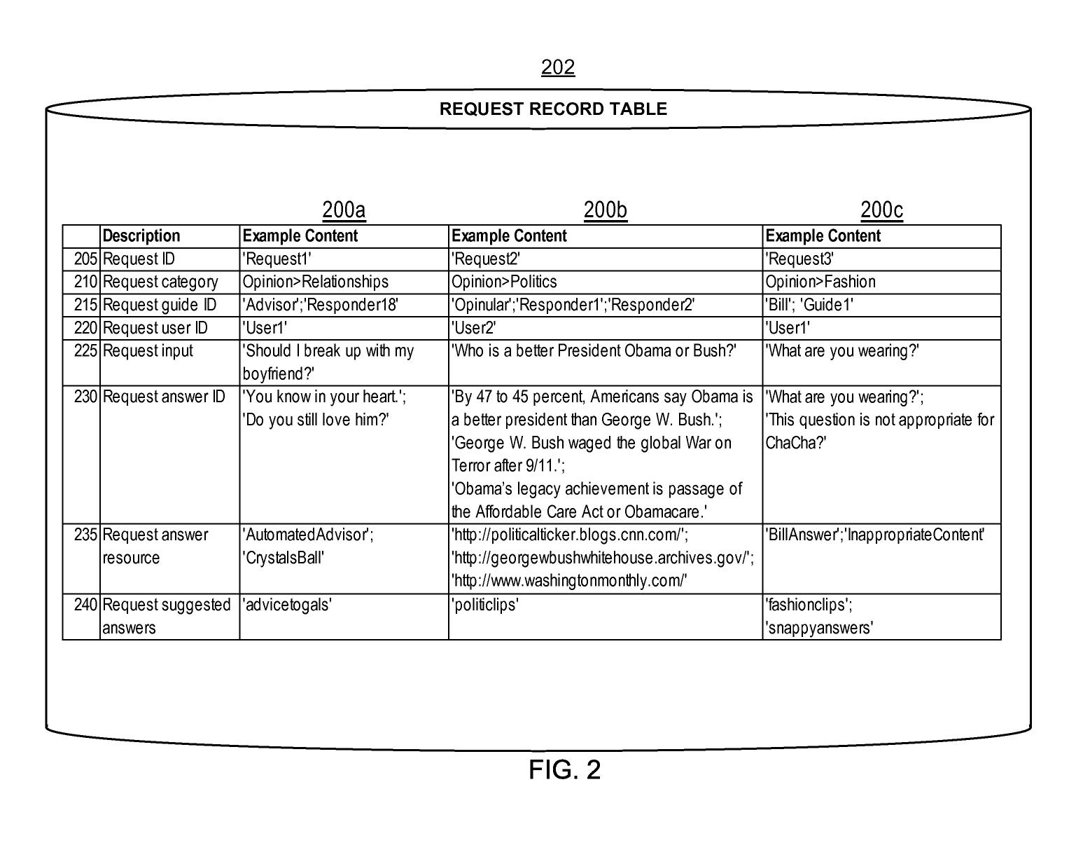

As illustrated in FIG. 2 an exemplary request record table 202 which may comprise a number of request records is provided. One or more request records 200a-c may be associated with or resident in the database 120 (FIG. 1). The request record table 202 may include information of requests which may be processed. The request records 200a-c may include a request ID field 205, a request category field 210, a request guide ID field 215, a request user ID field 220, a request input field 225, a request answer ID field 230, a request answer resource field 235 and a request suggested answers field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to determine who a request may be sent to such as a responder and/or an expert. Likewise, a category associated with a request may be used to rank requests which may be presented to a guide or responder. A category associated with a request may be determined based on factors such as keywords of a query, a profile of a user, a selection of a guide, a user history, etc. A category associated with a system taxonomy may be indicated in the request category field 210. A category may be associated with a request automatically and/or using the assistance of a person. Using the example in Fig. example in FIG. 2, ‘Request2’ may be categorized as ‘Opinion>Politics’ as indicated in the request record 200b. This may indicate that a person or item associated with the category ‘Opinion>Politics’ may have a higher ranking for responding to ‘Request2’. A category of a request may be associated with a request by a user submitting the request. Content of a request such as a keyword, named entity, etc. may be used to assign a category or type to a request. If a responder has elected to respond to requests a ranking of requests for a category associated with a responder may influence whether a request is provided to a responder.

The request guide ID field 215 may include information of a number of guides and/or responders associated with a request. Content of the request guide ID field 215 may be used to obtain information of a guide. If a person is selected for a request, elects to receive a request, provides a response to a request, reviews a result of a request and/or completes a request, an identifier of the person may be indicated in the request guide ID field 215. Using the example in FIG. 2, ‘Guide1’ and ‘Bill’ are associated with ‘Request3’. This may for example indicate that ‘Request3’ has been processed by ‘Bill’ and completed by ‘Guide1’. A response may be answered by any number of responders and/or guides. A response of a guide may cause a request to be blocked from presentation to other responders. For example, the selection of an answer indicating that a request is inappropriate is made by ‘Guide1’ ‘Request3’ might be blocked from presentation to responders and/or users based on information of a user such as demographics, affiliation, etc.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user request. For example, the search system 130 (FIG. 1) may provide requests to persons which are not directly related to a user request. The search system 130 may provide a request to a searcher based on a selection of the request by an advertiser, sponsor, etc. Using the example in FIG. 2, ‘User1’ is associated with ‘Request1’ and ‘Request3’ and ‘User2’ is associated with ‘Request2’. This may indicate that ‘Request1’ and ‘Request3’ were submitted by ‘User1’ while ‘Request2’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘What are you wearing?’ is the request input associated with ‘Request3’, as indicated in the request record 200c. This request depicts a social type question, which may be answered with a polite statement that the query is inappropriate, no answer, a joke, etc. This may differ from an automated answer to an unknowable type query such as an answer to ‘Should I break up with my boyfriend?’ associated with request record 200a. In at least one embodiment, the request input field 225 may indicate an original user request, a categorization, and a rewritten user request. Requests considered to be discussion type requests may also be provided. A discussion request may be a request which is an opinion query supportable by fact. Additional types of and/or subcategories of subjective questions may be used as determined suitable based on query analysis and behavior of users and/or responders. For example, subcategories may be assigned based on a subject matter and/or named entity associated with a request.

The request answer ID field 230 may include information of a response associated with a request. Content of the request answer ID field 230 may be provided responsive to a request. Content of the request answer ID field 230 may be stored in the database 120 (FIG. 1). Content of the request answer ID field 230 may be reviewed and/or rated by a user, a guide, and/or an administrator. As illustrated in FIG. 2, the response By 47 to 45 percent, Americans say Obama is a better president than George W. Bush ‘is associated with Request2’ and may have been answered by ‘Opinular’ as illustrated in the request record 200b. A response may be a stored response containing a named entity of a query that is rated highly for probability to be successful at answering a query. Such an answer may be obtained by techniques such as spidering and/or automated extraction of text which is closely related to named entities of a query. Additional responses may be made available providing opinions from a responder and/or a stored response which may be more pleasing to an asker may be provided. An automated response to a subjective query may be provided quickly, which may increase user engagement. A request answer ID may include an indicator of a response of any type. While a text response to a query is used for the purposes of illustration, any type of media may be indicated in the request answer ID field 230. The request record 200c may indicate that ‘Request3’ is responded to first by ‘Bill’ and then is deemed inappropriate by ‘Guide1’. This type of question may be presented to a responder rather than a guide if a responder has elected to accept such queries. For example, if a responder has elected to accept queries which may include coarse language, unfiltered images, etc. Likewise, a priority may be applied such that some types of questions are not provided to guides, that a rejection or flagging of a query as inappropriate or questionable by a responder may cause the query to be routed to a guide, etc.

The request answer resource field 235 may include information of a resource associated with a request. Content of the request answer resource field may be used to access a resource. A request answer resource may provide a response directly to a user. A request answer resource may provide a suggested response to a responder. Using the example in FIG. 2, the answer ‘You know in your heart’ is provided by the ‘AutomatedAdvisor’ resource as indicated in request record 200a. This may indicate ‘You know in your heart’ is an automated answered which is generated based on stored information and/or programmatically. Profile information of a requester may be used to determine a response, to select a resource, to modify a response, etc. An answer may be provided to a guide and/or responder who may select the response from responses provided. As illustrated in FIG. 2, the answer “Do you still love him?” may have been provided by the resource ‘CrystalsBall’ and selected by ‘Responder18’ to be provided to ‘Usert1’ as indicated in the request record 200a.

The request suggested answers field 240 may include information of suggested answers or responses. Content of the request suggested answers field 240 may include information obtained from a resource selected based on a request and/or information associated with a request such as a type, category, user, profile, keyword, affiliation, source, etc. Content of the request suggested answers field 240 may be rated and/or ranked based on an action of a responder. For example if an answer is selected by a responder a ranking of the answer may be increased, which may cause the answer to be more likely to be presented responsive to a request. Similarly if an answer is presented to a responder and is not selected, a ranking or rating of an answer may be reduced. A ranking of a resource which provides an answer may be affected by content of the request suggested answer field 240. For example, if a resource produces an answer which is selected by a responder a ranking or rating of a resource may be increased, which may make a resource more likely to be used to obtain suggested answers. A ranking or rating of a resource and/or an answer may be associated with any item such as a category, type, profile data, location, user, responder, keyword, and/or other information available to the search system 130 (FIG. 1). Content of the request suggested answer field 240 may include a pointer to a number of responses. As illustrated in FIG. 2, ‘advicetogals’ may might indicate a list which may include a number of possible answers which were obtained based on factors such as age, gender, location, affiliation, demographics, etc. of a user and/or a responder. If a responder elects to provide an answer indicated in the list, a ranking of a resource, algorithm, etc., used to obtain a list may be increased.

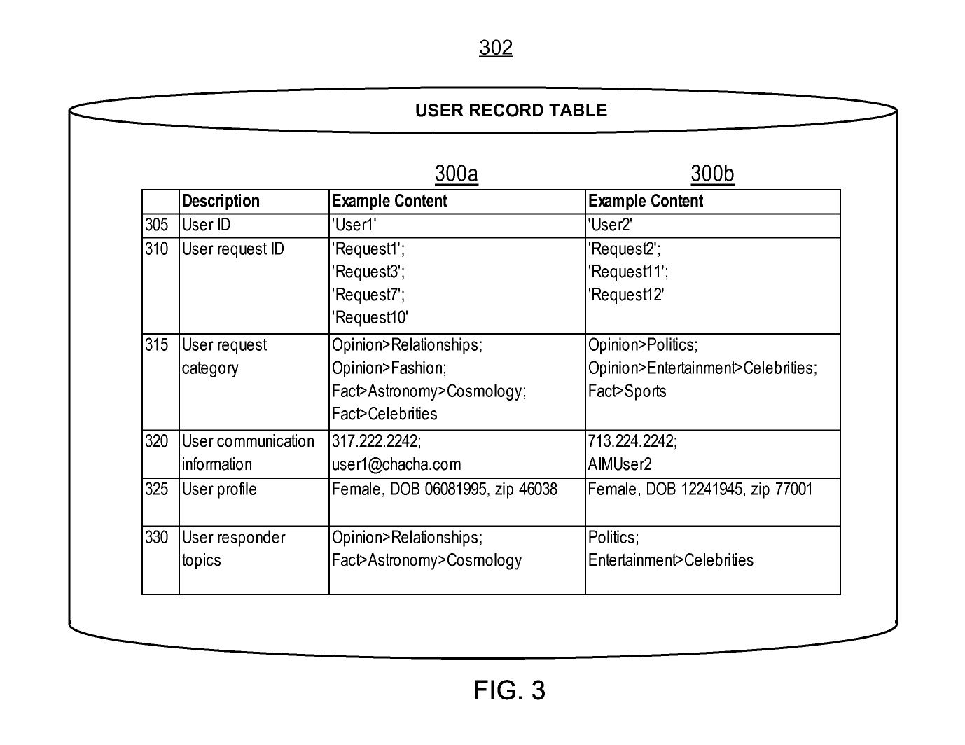

As illustrated in FIG. 3 an exemplary user record table 302, which may comprise a number of user records is provided. One or more user records 300a-b may be associated with or resident in the database 120 (FIG. 1). The user record table 302 may include information of users. The user records 300a-b may include a user ID field 305, a user request ID field 310, a user request category field 315, a user communication information field 320, a user profile field 325, and a user responder topics field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’ and ‘Request12’ are associated with ‘User2’ as indicated in the user record 300b. This may indicate that ‘User2’ has submitted ‘Request2’, ‘Request11’ and ‘Request12’.

The user request category field 315 may include information regarding a category or type associated with a user request. For example, if a request is directed to a type of processing or a category, etc. a type and/or category associated with the processing may be indicated in the user request category field 315. In at least one embodiment, the user request ID field 310 and the user request category field 315 are linked by for example a pointer. In at least one embodiment, a category associated with a request of a user may affect whether a responder answer will be provided. An affiliation of a user may affect a category associated with a request of a user. For example, if a user is a trusted user, requests may receive a human assisted response, or may be directed to a group of responders and/or guides based on an affiliation of a user. If a user has submitted queries categorized as ‘Relationships’ a user may be sent queries regarding ‘Opinion>Relationships’.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. An answer might be modified based on geographic, demographic, etc. profile information of a user. For example, a response to a query categorized as ‘Opinion>Relationships’ which was found to be of the type ‘unknowable’ might receive a different response based on age, gender, location, affiliation and/or any profile information associated with a user. Similarly discussion and/or social type opinion responses might be modified based on profile information of a user. A suggested answer might be affected by profile information of a user and/or responder.

The user responder topics field 330 may include information of query topics to which a user may respond. Content of the user responder topics field 330 may be used to determine whether a responder receives a particular query. For example, a user such as ‘User2’ may select the topics ‘Politics’ and ‘Entertainment>Celebrities’ as indicated in user request record 300b. This may indicate ‘User2’ is interested in responding to questions regarding ‘Politics’ and ‘Entertainment>Celebrities’ and queries pertaining to these topics may be more likely to be directed to ‘User2’.

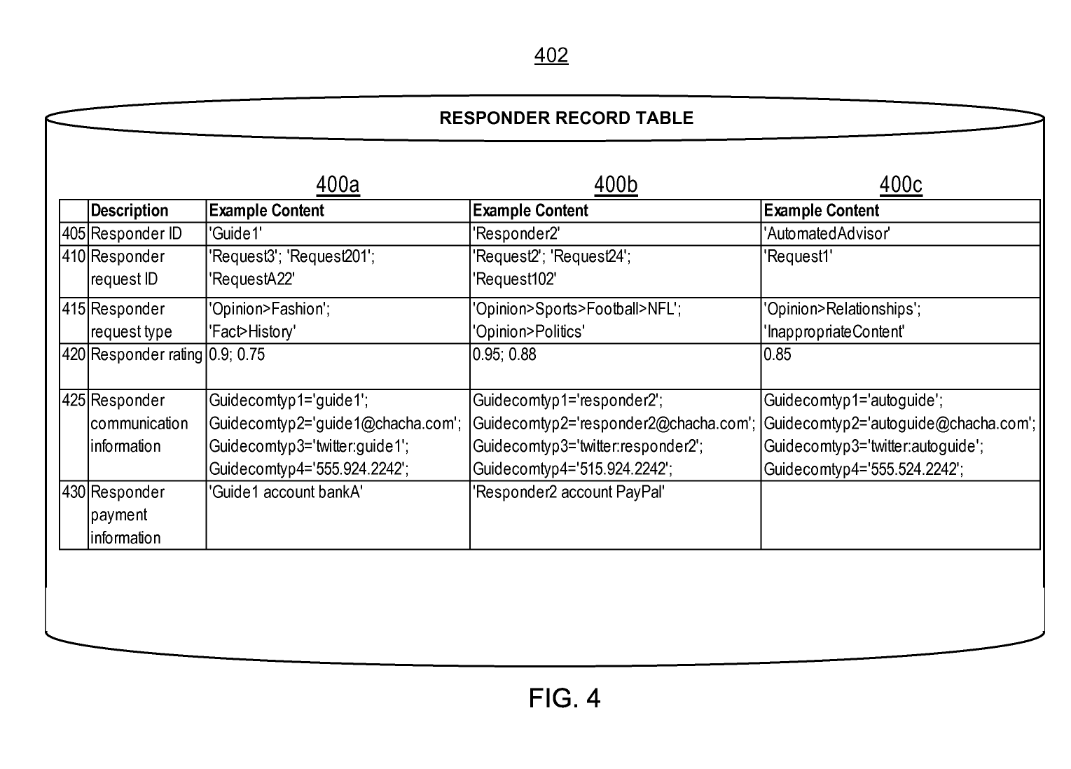

As illustrated in FIG. 4 an exemplary responder record table 402 which may comprise a number of responder records 400a-c is provided. One or more responder records may be associated with or resident in the database 120 (FIG. 1). The responder record table 402 (FIG. 4) may include information of responders. The responder records 400a-c may include a responder ID field 405, a responder request ID field 410, a responder request type field 415, a responder rating field 420, a responder communication information field 425, and a responder payment information field 430.

The responder ID field 405 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 405. In at least one embodiment, a pseudonym selected by a guide may be indicated in the responder ID field 405. Using the example in FIG. 4, ‘Guide1’ is the responder ID associated with the responder record 400a.

The responder request ID field 410 may include information of a number of requests associated with a responder. Content of the responder request ID field 410 may be used to obtain information of a request. For example, if a responder request has been determined to require a number of requests to be performed, the search system 130 (FIG. 1) may assign a unique ID to the requests and may distribute information of the requests to responders. Using the example in FIG. 4, ‘Request2’, ‘Request24’, and ‘Request102’ are associated with ‘Responder2’ as indicated in the responder record 400b. This may indicate that ‘Responder2’ has handled or responded to ‘Request2’, ‘Request24’ and ‘Request102’.

The responder request type field 415 may include information of a number of types of requests which may be processed by a responder. For example, a category and/or keyword associated with a request, a type of request, temporal information associated with a request, etc., which may be used to determine if a responder is to be presented with a request may be indicated in the responder request type field 415. In at least one embodiment, a responder may be assigned to a particular type of request as part of a registration process. A responder may select a type of request which the responder may perform. A responder may be required to pass a test in order to be associated with a type of request. A responder may be assigned to a role such as expert, searcher, expediter, etc., which may be indicated in the responder request type field 415. A request indicating a keyword may be directed to a responder based on a ranking of a responder for a keyword. Using the example in FIG. 4, ‘Guide1’ is associated with the request types ‘Opinion>Relationships’ and ‘Fact>History’. This may for example indicate that ‘Guide1’ may be presented with and/or selected to respond to requests indicating and/or ranked highly for those types.

The responder rating field 420 may include information of a number of ratings associated with a responder. For example, quality, speed, peer review, availability, number of answers, frequency of answers, etc., may be used to determine a rating of a responder. A rating of a responder may be used for purposes such as determining compensation for the responder, selecting a responder to respond to a request, matching a request to a responder, etc. In at least one embodiment, the responder request type field 415 and the responder rating field 420 may be linked by, for example, a pointer. Using the example in FIG. 4, ‘Responder2’ has a rating of ‘0.95’ associated with ‘Opinion>Sports>Football>NFL’, and a rating of ‘0.88’ associated with ‘Opinion>Politics’ which may be used to rank ‘Responder2’ versus other responders and/or guides associated with the request types ‘Opinion>Sports>Football>NFL’ and ‘Opinion>Politics’.

The responder communication information field 425 may include information of a number of communication services associated with a responder. For example, a user name and password, an email address, an IM credential, a phone number, a web page, a physical address, etc., may be indicated in the responder communication information field 425. Using the example illustrated in FIG. 4, ‘AutomatedAdvisor’ is associated with the login ID ‘autoguide’, the email ‘autoguide@chacha.com’, the Twitter account ‘twitterautoguide’, and the phone number ‘555.524.2242’. This may indicate that information from ‘AutomatedAdvisor’ may be obtained using the associated communication services.

The responder payment information field 430 may include information of a payment method associated with a responder. For example, banking information, a PayPal® account, a Western Union® account, etc., may be indicated in the responder payment information field 430. Content of the responder payment information field 430 may be used to provide compensation to a responder. For example, payment may be made by Automated Clearing House (ACH), wire transfer, etc., using information indicated in the responder payment information field 430. As indicated in FIG. 4, the responder ‘Guide1’ is associated with ‘Guide1 account bankA’ which may indicate that compensation accrued by ‘Guide1’ may be paid to ‘Guide1 account bankA’. An automated resource may be paid if for example, the automated information is provided by a database service or other form of automation.

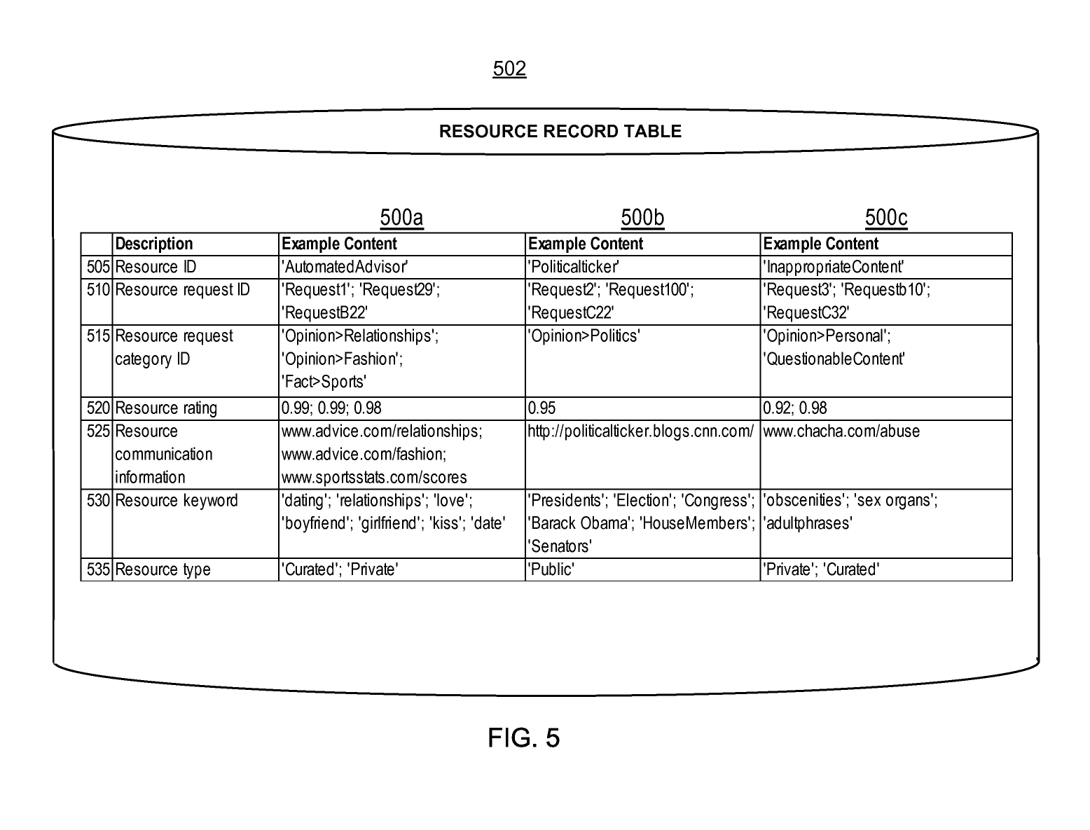

As illustrated in FIG. 5 an exemplary resource record table 502 which may comprise a number of resource records 500a-c is provided. One or more resource records may be associated with or resident in the database 120 (FIG. 1). The resource record table 502 (FIG. 5) may include information of resources. The resource records 500a-c may include a resource ID field 505, a resource request ID field 510, a resource request category ID field 515, a resource rating field 520, a resource communication information field 525, a resource keyword field 530, and a resource type field 535.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘AutomatedAdvisor’ is the resource ID associated with the resource record 500a.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request3, ‘Requestb10’ and ‘RequestC32’ are associated with the resource ‘InappropriateContent’ as indicated in the resource record 500c. This may indicate that a response from the resource ‘InappropriateContent’ has been utilized to respond to ‘Request3’, ‘Requestb10’ and ‘RequestC32’.

The resource request category ID field 515 may include information of a number of categories of requests which may be processed by a resource. For example, a category and/or keyword associated with a request, a type of request, profile, etc., which may be used to determine if a resource is to be presented to a guide for a request may be indicated in the resource request category ID field 515. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, ‘AutomatedAdvisor’ is associated with the categories ‘Opinion>Relationships’, ‘Fact>Sports’, and ‘Opinion>Fashion’ as indicated by the resource record 500a. This may indicate that a provider of ‘AutomatedAdvisor’ has indicated an interest in responding to those categories of requests.

The resource rating field 520 may include information of a number of ratings associated with a resource. For example, a rating of a resource may be based on ratings of answers produced using the resource, a contractual agreement, an affiliation, temporal information such as time spent by guides, a number of answers selected by responders, etc. A rating of a resource may be used to select a resource which is provided to a searcher or guide, to rank a response associated with a resource, to determine whether to submit a request to a resource, etc. In at least one embodiment, the resource request category ID field 515 and the resource rating field 520 may be linked by, for example, a pointer. Using the example in FIG. 5, ‘AutomatedAdvisor’ has a rating of ‘0.98’ associated with ‘Opinion>Fashion’ and ‘InappropriateContent’ was a rating of 0.92 for ‘Opinion>Fashion’. This may indicate that ‘AutomatedAdvisor’ is more likely to provide a suitable answer to a request associated with ‘Opinion>Fashion’. A resource may have a rating corresponding to various categories, types of information, types of tasks, types of requests, keywords, etc.

The resource communication information field 525 may include information of a number of communication services associated with a resource. For example, a user name and password, an email address, an IM credential, a phone number, a web page, a physical address, etc., may be indicated in the resource communication information field 525. A communication service indicated in the resource communication information field 525 may for example be used to indicate a service by which a resource may be accessed. Using the example illustrated in FIG. 5, the URL <<www.chacha.com/abuse>> is associated with ‘InappropriateContent’. This may indicate that a query associated with ‘Opinion>Fashion’ may be submitted to that URL by for example an API. An API request to a resource may include information associated with a request such as profile information of a user, etc.

The resource keyword field 530 may include information of a number of keywords, images, media and/or content associated with a resource. A match to information indicated in the resource keyword field 530 may affect a probability that a request will receive a response associated with a resource. The resource keyword field 530 may include keywords, media and/or a pointer to information. For example, ‘obscenities’ and ‘sex organs’ are indicated in the resource record 500c, which may point to a list of keywords, Regular Expressions (RegEx), phrases, pseudonyms, etc., which may trigger a classification of query as inappropriate for a type of responder and/or user. A match to information indicated in the resource keyword field 530 may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. A URL associated with a resource may be compared to a URL of a result.

The resource type field 535 may include information of a number of types or characteristics associated with a resource. A type may include an indication of an access right, a commercial arrangement, a preference, quality of content, source of content, classification or category, etc. A searcher may elect to associate a resource with a type. A system administrator may associate a type with a resource. A provider of a resource may designate a type associated with the resource as part of a registration process and/or other activity. Using the example in FIG. 5, ‘AutomatedAdvisor’ is a ‘Private’, ‘Curated’ resource. This may indicate that content of the AutomatedAdvisor resource is not accessible to the general public and that the content of the resource is verified to be correct.

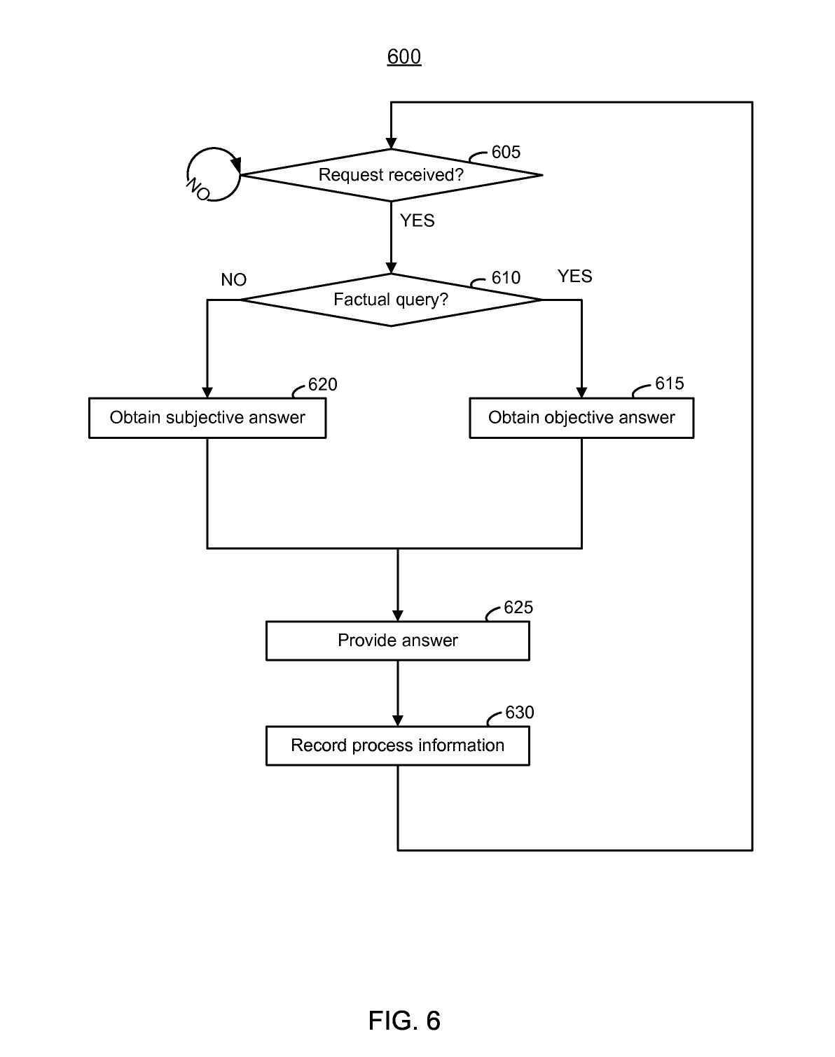

As illustrated in FIG. 6, a process 600 for responding to a query is provided. The process 600 may be performed in whole or in part by any suitable element of the system 100 (FIG. 1). In at least one embodiment, the process 600 is operative on a server associated with the search system 130. A request may be a request for an automated answer, a human assisted answer and/or a combination thereof.

In operation 605 (FIG. 6) a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received.

In operation 610 (FIG. 6) a determination is made as to whether a query is factual. If it is determined in operation 610 that a query is factual, control is passed to operation 615 and process 600 continues. If it is determined in operation 610 that query is not factual, control is passed to operation 620 and process 600 continues.

The determination in operation 610 may be made using various criteria. In at least one embodiment, if a message is received which requires a known factual response it may be determined that a query is factual. For example, queries regarding dates, geography, etc., may require a factual response whereas at other times a user may want an opinion to a query. For example, a user may want advice on a relationship, a comparison of two things, etc., which require a person's opinion on a topic rather than a factual response. A filter such as a Bayesian detector may be applied to a request to determine whether a request is subjective and/or objective. Various types of algorithms may be more likely to produce a false negative, and thus a detector of an objective and a subjective type query may be applied. If an automated system is unable to determine whether a query is factual, the query may be routed to a number of human assistants, who may provide an input as to whether a query is factual.

In operation 615 an objective answer is obtained. An objective answer may be obtained for a query seeking factual information. A user may be seeking information which is either stored in the database and/or which may be obtained by a responder. For example, a user may want to know a date for a sporting event, a past quote for a security, etc., which is a verifiable fact rather than a subjective answer. Control is passed to operation 625 and process 600 continues.

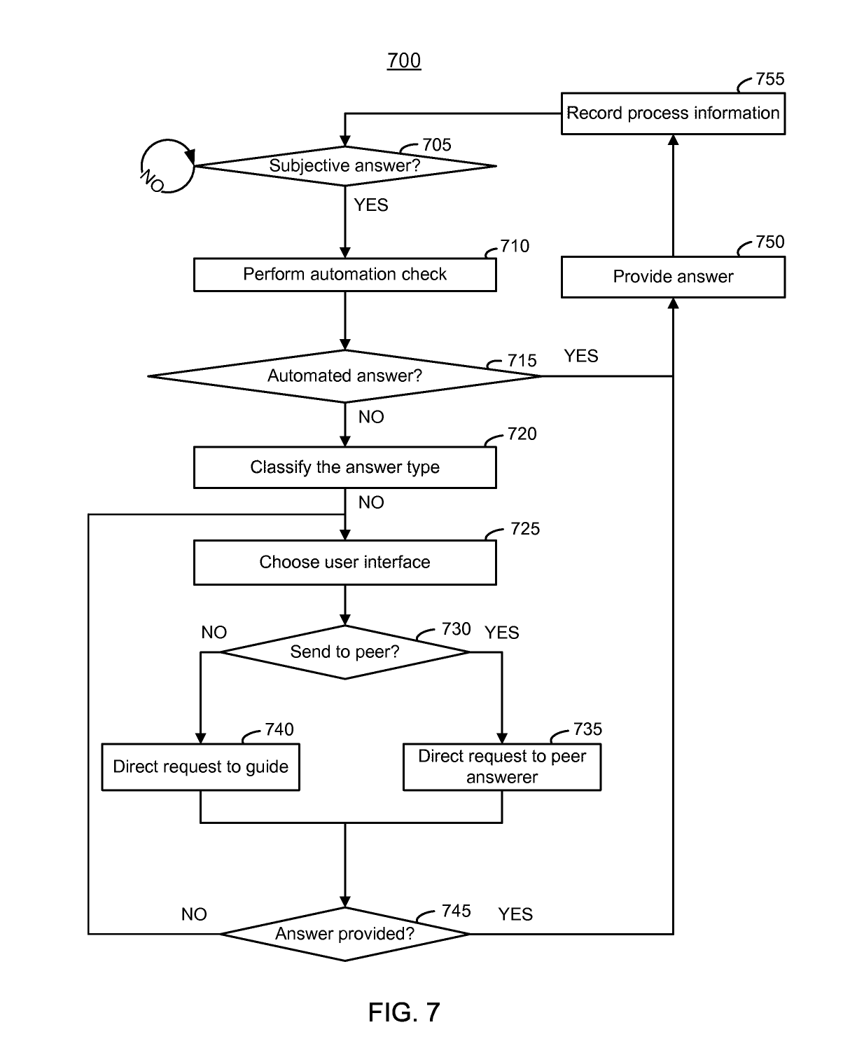

In operation 620 a subjective answer is obtained. A subjective answer may be an automated answer stored in a database in response to a user request for a joke, a riddle, advice, etc. A subjective answer may be provided by a responder expressing an opinion about a topic and/or may be obtained from information matching a named entity of a query within a database and/or other media or resource. A response to a subjective query may not require specific knowledge, but may require a polite and/or appropriate answer based on a set of criteria. Criteria for a subjective response may be determined based on information of a source of a request. Demographic criteria such as age, ethnicity, income, education, affiliation, religion, etc., may influence and/or determine a criterion for a subjective response. Historical information associated with a source of a request may be used to determine a criterion of a subjective response. A process of responding to a subjective query is further described herein with respect to FIG. 7. Control is passed to operation 625 and process 600 continues.

In operation 625, an answer is provided. Any number of answers may be provided. A highest ranking answer may be provided. An answer may be provided in an order based on rank of the answer. An answer may be subjective and/or objective. Control is passed to operation 630 and process 600 continues.

In operation 630, process information is recorded. Information of a request, a sponsored answer or ancillary content, an answer, a resource, a user, a sponsor, a guide, a rating, a ranking, etc., may be recorded. A stored response may be rated, ranked, or deleted. Usage and compensation associated with content obtained from a provider may be recorded. In at least one embodiment, process information is recorded in the database 120 (FIG. 1). Control is passed to operation 605 and process 600 continues.

As illustrated in FIG. 7, a process 700 for processing a subjective query is provided. The process 700 may be performed in whole or in part by any suitable element of the system 100 (FIG. 1). In at least one embodiment, the process 700 is operative on a server associated with the search system 130. A request may be a request for an automated answer, a human assisted answer and/or a combination thereof.

In operation 705 (FIG. 7) a determination is made as to whether a subjective answer is requested. If it is determined in operation 705 that a subjective answer is not requested, control remains at operation 705 and process 700 continues. If it is determined in operation 705 that a subjective answer is requested, control is passed to operation 710 and process 700 continues.

The determination in operation 705 may be made using various criteria. In at least one embodiment, if a message is requesting information which is unknowable, an opinion, an opinion supported by fact, etc., it may be considered to be a subjective query. For example, if an email message, an SMS, EMS, and/or MMS message, an IM, an IP message, and/or a voice message is received at an address associated with the search system 130, it may be determined that a request for a subjective answer is received. If a message is received at a server associated with the search system 130, it may be determined that a subjective answer request is received. A subjective request may be received by a device such as the guide system 135 rather than or in addition to being received by the search system 130.

In operation 710 an automation check is performed. A query may be compared to previous queries when running an automation check. An automation check may provide information as to whether an automated answer may exist. An automation check may provide information as to whether a subjective user query is unknowable, supportable by fact, conversational, associated with a category, a type, etc. A profile associated with a user may be used to determine whether an automated response is available responsive to a subjective request or question. Automation checking may be affected by a number of requests submitted by a user, historical information of a user, compensation offered by a user, a demographic, geographic and/or other attribute of a user. Automation may include use of programmatically generated sentences which are based on a request and/or a user. For example, an automated response may be differentiated based on age, gender, topic, location, type, etc., associated with a subjective request. Control is passed to operation 715 and process 700 continues.

In operation 715 (FIG. 7) a determination is made as to whether an automated answer is provided. If it is determined in operation 715 that an automated answer is provided control is passed to operation 750 and process 700 continues. If it is determined in operation 715 that an automated answer is not provided control is passed to operation 720 and process 700 continues.

The determination in operation 715 is made using various criteria. In at least one embodiment, if a query has been previously received, and/or is stored in a resource or database a query may be answered using an automated answer. An answer provided by a responder responsive to a type of question may be stored in a database and provided automatically based on keywords, profile information, etc. An automated answer may also be used to provide information regarding opinion questions which may be supported by facts. For example, if a stored response to a question regarding a prediction regarding a future event has not become obsolete and is found to match a user request, a stored response may be provided. An automated answer may always be provided to some types of questions. An automated answer may not be provided to some types of questions.

In operation 720 a query is classified. A subjective query may be classified using the assistance of a person and/or automatically. For example a classifier such as Bayesian filter, RegEx filtering, and/or semantic filtering may be used to automatically classify a subjective request. A person may classify a request. For example, if a request is offered as a particular type of request, acceptance or rejection of that type by a person such as a user and/or a responder or guide may be used to classify a request. Classification of a request may be performed based on implicit actions of persons such as responders. Control is passed to operation 725 and process 700 continues.

In operation 725 a user interface is chosen. A user interface may be chosen to be presented to a responder and/or a guide based on a classification or type assigned to a subjective request. A responder may choose a user interface to determine which response may be provided. A user interface may include information of multiple resources and responses from which a responder may choose to send to a user a response. A user interface may be directed to a category or type of information assigned to a request. Control is passed to operation 730 and process 700 continues.

In operation 730 (FIG. 7) a determination is made as to whether to send a request to a peer. If it is determined in operation 730 to send a request to a peer control is passed to operation 735 and process 700 continues. If it is determined in operation 730 not to send a request to a peer control is passed to operation 740 and process 700 continues.

The determination in operation 730 may be made using various criteria. In at least one embodiment a response may be sent to a peer if control of content of a response is not necessary. A peer answerer may be excluded if it is necessary to control content, etc., which is provided to a user. For example, if content is required to be age-appropriate, free of images, or filtered to comply with a guideline associated with a user, a peer answerer may be excluded from responding. A guide may be chosen if a peer is unavailable, takes longer than a prescribed amount of time, provides an incorrect and/or unsuitable answer, etc. A peer may be selected for a query which is selected by a peer, associated with a keyword of a peer or responder, does not require advertising or response control, for an opinion query for which a peer has registered, etc. A request may be sent to a peer based on a type of a request, an attribute of a user, a number of peers available, an amount of time which has elapsed, etc. A request may be directed to any number of peers and/or guides.

In operation 735 a request is directed to a peer answerer. A request may be directed to a peer answerer who may be interested in a topic. A responder may be a peer answerer if the responder signs up for topics, categories and named entities to which the responder may be interested in responding which match a request. A peer responder may be likely to provide a good answer but may not be compensated for such an answer. A responder may not be a specialist or person with domain specific knowledge regarding a request. Control is passed to operation 745 and process 700 continues.

In operation 740 a request is directed to a guide. A request may be directed to a guide who may be trained to respond to requests associated with a group of topics. A guide may be trained to respond to a particular category, topic and/or named entity associated with a request. A guide may be provided payment for services. A guide may be used if a peer answerer is unavailable. A guide may be provided with a toolset based on a type of device a guide is operating. A guide may be a generalist who may respond to all types of requests. Control is passed to operation 745 and process 700 continues.

In operation 745 (FIG. 7) a determination is made as to whether an answer is provided. If it is determined in operation 745 that an answer is not provided control is passed to operation 725 and process 700 continues. If it is determined in operation 745 that an answer is provided control is passed to operation 750 and process 700 continues.

The determination in operation 745 may be based on various factors. An answer may not be provided if a user is satisfied with a previous answer. An answer may not be provided if the answer is not an appropriate response to a request and/or is not a timely response. For example, if a peer answer includes a word from an exclusion list, is rejected by a user, is delivered after a pre-determined time period, etc., it may be determined that an answer is not provided. If a user does not approve a response, another response may be obtained automatically and/or by a peer and/or a guide.

In operation 750, an answer is provided. Any number of answers may be provided. A highest ranking answer may be provided. A sponsored answer may be provided. Content not directly related to a request may be provided as a portion and/or the entirety of an answer. An answer may include any suitable media which may be utilized by a user device. Automated and/or human-assisted answers, content, etc., may be provided in any order and/or timing. Control is passed to operation 755 and process 700 continues.

In operation 755, process information is recorded. Information of a request, an answer, a category, a keyword, a resource, a resource, a toolset, a user, a sponsor, a guide, a responder, a rating, a ranking, etc. may be recorded. A stored response may be rated, ranked, and/or deleted. Information of a type associated with a request may be stored. For example, if a responder responds using a user interface associated with a type, a probability associated with the type and information of a request may be adjusted to reflect that similar requests may be more likely to be associated with the type. For example, a filtering algorithm, a hashing function, etc., may be adjusted based on a type assigned to a request or query and/or interactions with persons such as responders, users and guides. In at least one embodiment, process information is recorded in the database 120 (FIG. 1). Control is passed to operation 705 and process 700 continues.

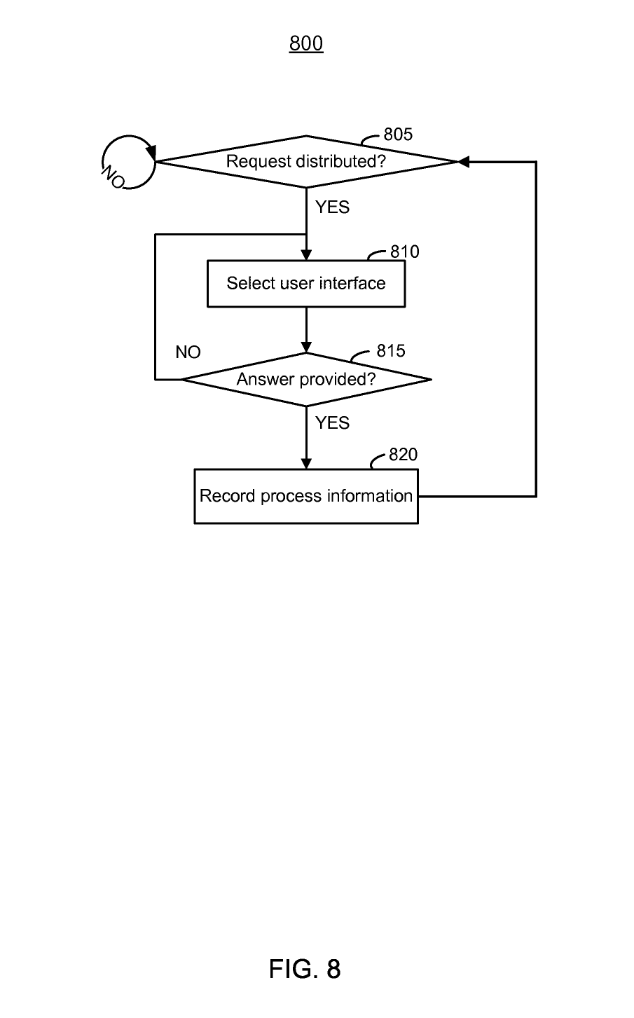

As illustrated in FIG. 8, a process 800 for responding to an opinion query from the perspective of a responder is provided. The process 800 may be performed in whole or in part by any suitable element of the system 100 (FIG. 1). In at least one embodiment, the process 800 is operative on a server associated with the search system 130. The process 800 may be operative on a device such as the user system 105 and/or the guide system 140 (FIG. 1). A request may be a request for an automated answer, a human assisted answer and/or a combination thereof.

In operation 805 (FIG. 8) a determination is made as to whether a request is distributed If it is determined in operation 805 that a request is not distributed, control remains at operation 805 and process 800 continues. If it is determined in operation 805 that a request is distributed, control is passed to operation 810 and process 800 continues.

The determination in operation 805 may be made using various criteria. In at least one embodiment, a request is distributed if it is sent to a peer or a guide. A request may be distributed to any party determined to be capable of responding to a query. For example, if a system implements an API associated with answering a type of request, the system may be determined to be capable of responding to requests of that type.

In operation 810 (FIG. 8) a user interface is selected. A user interface may be selected based on a type of query. For example, a subjective query may fall into one of a number of categories such as Type 1, Type 2, and Type 3. A query regarded as Type 1 may be an unknowable query such as ‘Should I break up with my boyfriend?’ or ‘Will the Colts win the Super Bowl?’ A Type 2 query may be a query which may be supported by factual information such as a comparison of two entities, or a topic on which multiple points of view may be expressed. A Type 3 query may be a query which is social content which seeks interaction without relying on domain-specific knowledge. A user interface such as the user interfaces depicted and described further herein may be selected to be provided to a person responding to a request. For example, an applet or “App” resident on a user device may be directed to present a specified user interface or “View” or “Activity” based on a most likely classification of a request. Different user interfaces may be selected for different responders when a classification has not been determined for a request and a selection by a responder may be used to determine whether a type assigned to a query is suitable. For example, a request may be presented using one possible categorization to a first responder to accept a request and might be presented with a different possible categorization to a second responder to accept the request. A user interface may be selected based on an action of a responder. For example, a responder may elect to change to a user interface other than a user interface selected by the search system 130 (FIG. 1). Control is passed to operation 815 and process 800 continues.

In operation 815 (FIG. 8) a determination is made as to whether an answer is provided. If it is determined in operation 815 that an answer is provided control is passed to operation 820 and process 800 continues. If it is determined in operation 815 that an answer is not provided control is passed to operation 810 and process 800 continues.

The determination in operation 815 may be based on various factors. If a responder indicates that an answer is suitable, it may be determined that an answer is provided. If a responder selects a different user interface, it may be determined that an answer is not provided. If a responder does not respond within a time interval, it may be determined that an answers is not provided. Any suitable criteria may be used to determine whether an answer is provided.

In operation 835, process information is recorded. Information of a request, an answer, a category, a keyword, a resource, a toolset, a user, a sponsor, a guide, a responder, a rating, a ranking, etc. may be recorded. A stored response may be rated, ranked, or deleted. Information of a type may be stored. For example, if a responder responds using a user interface associated with a type a probability associated with the type and information of a request may be adjusted. If a responder selects a response from a resource, a ranking of a resource associated with a type and/or content of a request may be increased. Content of an answer may be stored for responding to future requests. In at least one embodiment, process information is recorded in the database 120 (FIG. 1). Control is passed to operation 805 and process 800 continues.

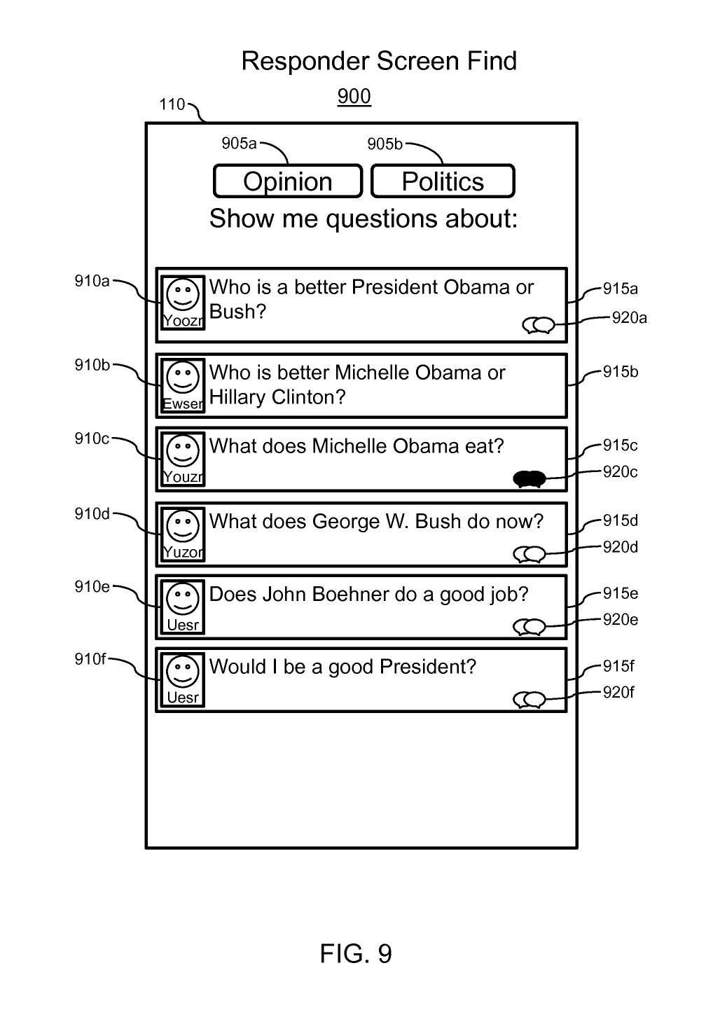

As illustrated in FIG. 9 an exemplary query selection GUI 900 is provided. The GUI 900 may be provided to a user, a responder, a guide, etc. The GUI 900 may be presented using a system such as the user system 110 (FIG. 1). The GUI 900 may be used to obtain information of a query. The GUI 900 may include query selection indicators 905a-905b, query indicators 915a-915f, user indicators 910a-910f, and conversation indicators 920a-920f.

As illustrated in FIG. 9, the category indicators 905a, 905b may include a category, type, etc., which may be used to select a query. The category indicator 905a may indicate that queries classified as ‘Opinion’ are to be provided. The category indicator 905b may indicate that queries classified as ‘Politics’ are to be provided. If a user activates the category indicator 905b queries regarding politics may be provided as illustrated in FIG. 9. Activation of a category indicator may allow selection of alternate criteria for filtering and/or selection of requests. Any number of category indicators may be provided. The user indicators 910a-910f may indicate information of a user associated with a request. For example, the user indicator 910b may indicate that ‘Ewser’ has submitted the query ‘Who is better Michelle Obama or Hilary Clinton?’ as indicated in the query indicator 915b. As illustrated in FIG. 9, the conversation indicators 920a-920f may indicate that a user associated with a request is available for a two-way communication. For example, the conversation indicator 920a may indicate that ‘Yoozer’ is available for a real-time exchange of information. Activation of the conversation indicator 920d might initiate a communication session with ‘Yuzor’ as indicated by the user indicator 910d. If a user associated with a request or question is unavailable for a real-time exchange for any reason, the condition may be indicated by for example the shading associated with the conversation indicator 920c, or the absence of a conversation indicator as illustrated in the query indicator 915b. Any suitable indicator such as color, shading, etc., may be used to indicate status of the conversation indicators 920a-920f.

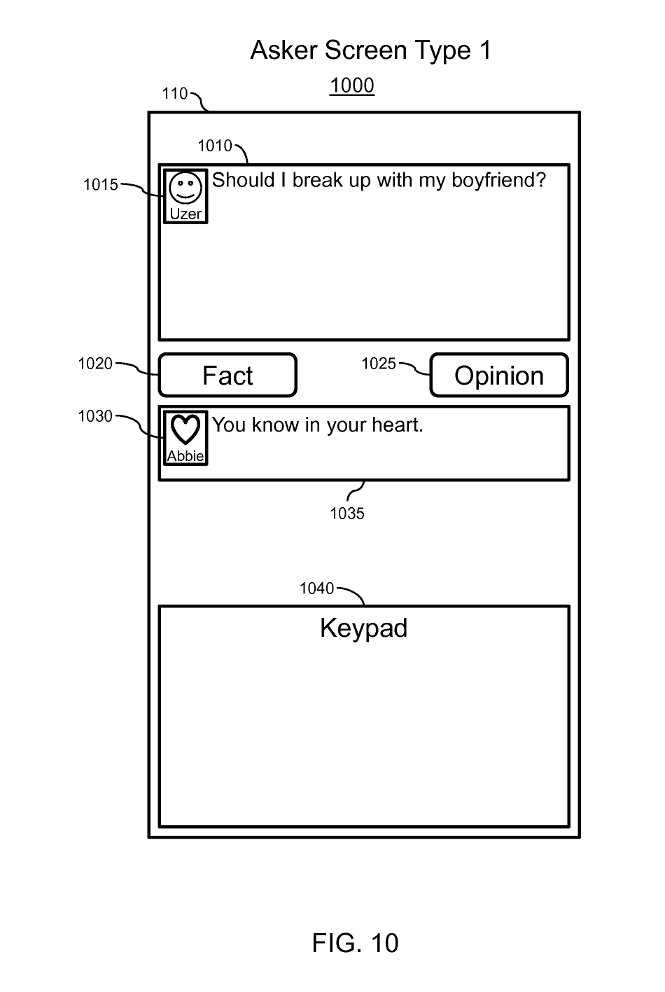

As illustrated in FIG. 10 an exemplary GUI 1000 is provided. The query submission GUI 1000 may be provided to a user. The GUI 1000 may be presented using a system such as the user system 105 (FIG. 1). The GUI 1000 may be used to submit any type of request and receive a response. A request may include media such as audio, video, images, etc. The GUI 1000 may include a query entry area 1010, a user identifier 1015, a factual query indicator 1020, an opinion query indicator 1025, a responder indicator 1030, a response indicator 1035, and a user input control 1040.

The request entry area 1010 may be used to indicate information of a request. The user identifier 1015 may be used to indicate information of a user submitting a request. The factual query indicator 1020 may be used to indicate that a request is a request for factual information. The opinion query indicator 1025 may be used to indicate that a request is a request for subjective information. Additional indicators may be provided based on a category, type, etc. of a request. The responder indicator 1030 may be used to indicate a source of a response. The response indicator 1035 may be used to indicate a response associated with a request indicated in the request indicator 1010. For example, the request entry area may include a query such as ‘Should I break up with my boyfriend?’ which may be answered with an answer indicated in the response indicator 1035. The responder indicator 1030 may indicate a source of a response. A response may be an automated response, a stored response, and/or a response provided using a human assistant. The user input control 1040 may be used to submit a request. While a keypad is used for purposes of illustration, any input device which is well known in the art may be used to implement the user input control 1040. Any elements of the GUI 1000 may be suppressed as required by an embodiment. For example, the factual query indicator 1020 and the Opinion query indicator 1025 might be suppressed and/or combined if an embodiment is targeted only for subjective requests.

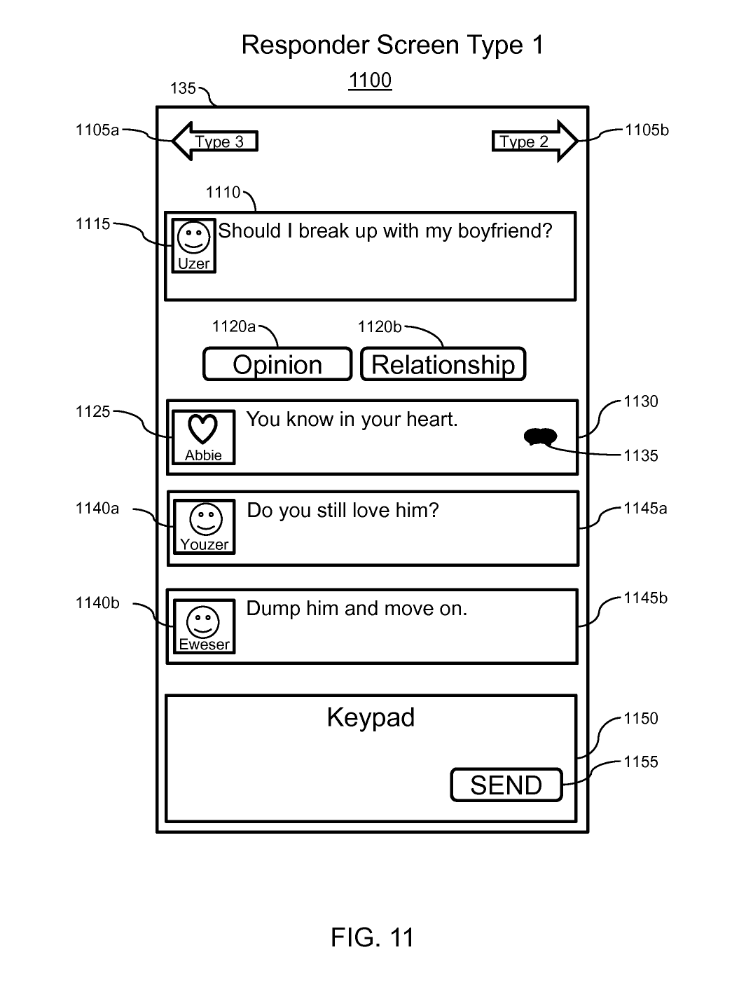

As illustrated in FIG. 11 an exemplary GUI 1100 is provided. The type one responder GUI 1100 may be provided to a responder and/or a guide. The GUI 1100 may be presented using a system such as the guide system 135 (FIG. 1). The GUI 1100 may include user interface selection controls 1105a, b, a query indicator 1110, a user identifier 1115, query type indicators 1120a, b, responder identifiers 1125, response indicators 1130, a responder conversation indicator 1135, responder avatars 1140a, b, suggested response indicators 1145a, b, a responder input control 1150 and a response submission control 1155. The GUI 1100 may be presented if the query is determined to be requesting an unknowable opinion. Unknowable opinions may be opinions regarding future events, rhetorical questions, or other types of responses for which there is limited or no factual basis for forming an opinion.

The user interface selectors 1105a, 1105b may be used to select alternate user interfaces which may be more suitable for responding to a request. The query indicator 1110 may indicate information of a request such as ‘Should I break up with my boyfriend?’ The user identifier 1115 may include information of a user submitting a request, which may be useful when selecting an appropriate response. The user indicator 1115 may provide demographic, geographic, etc., information of a user. The query type indicators 1120a, 1120b may be used to indicate categories, topics, etc. associated with a query. A type or category may be associated with a query automatically and/or using the assistance of a person such as a user and/or responder. The responder indicator 1125 may be used to indicate information of a responder associated with an answer. For example, the responder ‘Abbie’ as indicated by the responder indicator 1125 may have provided the answer “You know in your heart.” as indicated by the response indicator 1130. A responder may be provided with a number of suggested answers matching a user request. For example, the responses “Do you still love him?” and “Dump him and move on” are indicated by the response indicators 1145a, and 1145b respectively. Activation of a response indicator may cause content indicated by a response indicator to be provided to a user submitting a request. For example, activation of the response indicator 1145a may cause the answer and the responder avatar 1140a to be provided to a user. A responder avatar may indicate a current responder and/or may indicate a source of an answer. A responder may elect to provide a free-form response using the responder input control 1150, which may cause a responder identifier and an answer associated with a responder to be provided to a user when the response submission control 1155 is activated.

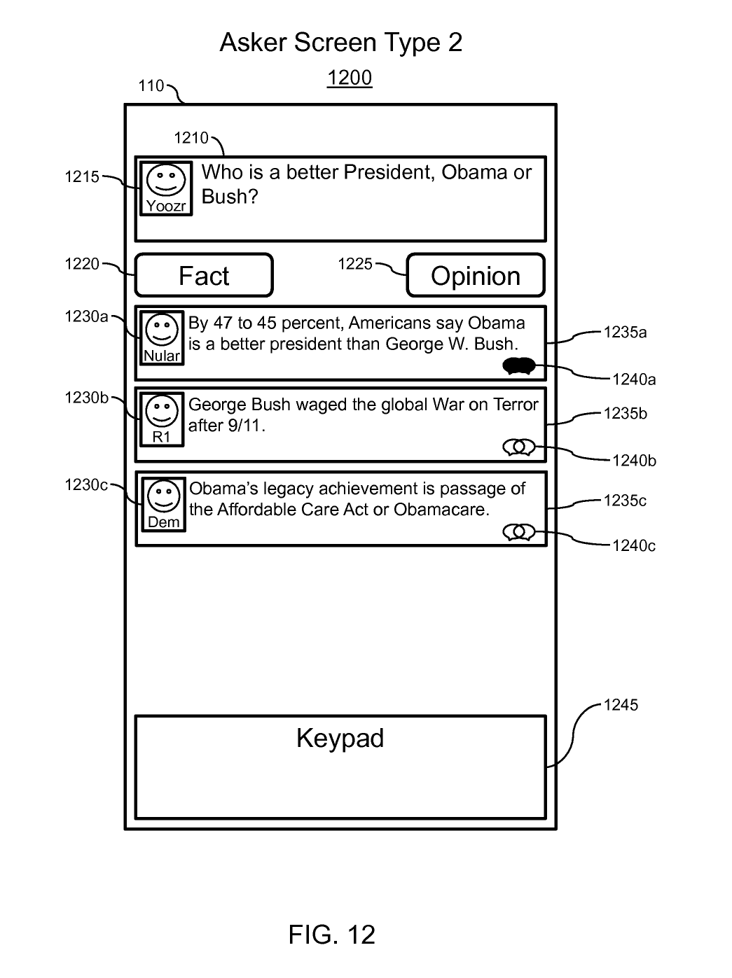

As illustrated in FIG. 12 an exemplary GUI 1200 is provided. The supportable opinion response reception GUI 1200 may be provided to a user. The GUI 1200 may be presented using a system such as the user system 110 (FIG. 1). The GUI 1200 may be used to submit any type of request and receive a response. The GUI 1200 may include a query entry area 1210, a user identifier 1215, a factual query indicator 1220, an opinion query indicator 1225, responder indicators 1230a-1230c, response indicators 1235a-1235c, conversation indicators 1240a-1240c, and a user input control 1245.

The request entry area 1210 may be used to indicate information of a request. The user identifier 1215 may be used to indicate information of a user submitting a request. The factual query indicator 1220 may be used to indicate that a request is a request for factual information. The opinion query indicator 1225 may be used to indicate that a request is a request for subjective information. The responder indicators 1230a-1230c may be used to indicate a source of a response. For example, the response indicator 1230a indicates that ‘Nular’ has submitted the response indicated in the response indicator 1235a. The response indicators 1235a-1235c may be used to indicate a response associated with a request indicated in the request indicator 1210. For example, the responder indicator 1230b may indicate that ‘R1’ provided the response ‘George Bush waged the Global War on Terror after 9/11.’ as indicated in the response indicator 1235b. An automated answer may be used when an answer is one which may be unknown, but for which a general response would be appropriate. For example, the responder ‘Nular’ indicated by the responder indicator 1230a may be an automated system which has selected information based on an index, spidering, and/or other form of automated selection of an answer based on a query. The conversation indicators 1240a-1240c may be used to initiate a real time two-way communication with a respective responder. The user input control 1245 may be used to submit a request. While a keypad is used for purposes of illustration, any user input device which is well known in the art may be used to implement the user input control 1245.

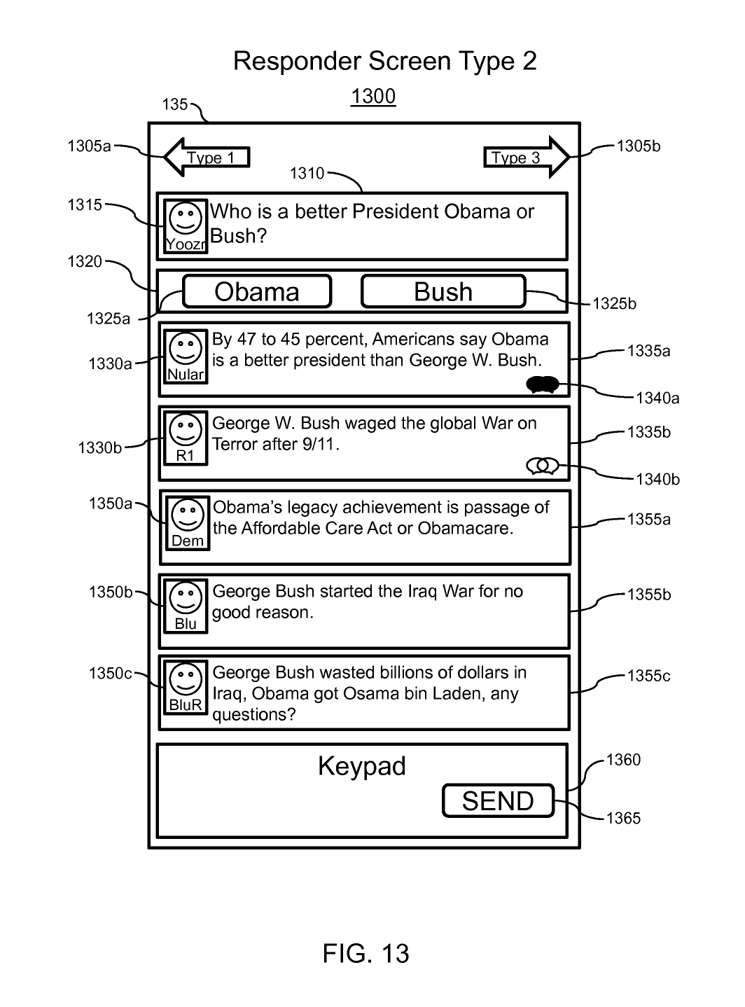

As illustrated in FIG. 13 an exemplary GUI 1300 is provided. The type two responder screen GUI 1300 may be provided to a responder and/or a guide. The GUI 1300 may be presented using a system such the guide system 135 (FIG. 1). The GUI 1300 may include response type indicators 1305a-1305b, a query indicator 1310, a user identifier 1315, a response control 1320, response selection indicators 1325a, 1325b, responder identifiers 1330a, 1330b, response indicators 1335a, 1335b, conversation indicators 1340a, 1340b, responder avatars 1350a-1350c, suggested response indicators 1355a-1355c, input controls 1360 and a response submission control 1365.

The user interface selectors 1305a, 1305b may be used to select alternate user interfaces which may be more suitable for responding to a request. The query indicator 1310 may indicate information of a request such as ‘Who is a better President Obama or Bush?’ The user identifier 1315 may include information of a user submitting a request, which may be useful when selecting an appropriate response. Affiliation, demographic, etc., information of a user may be provided by activating the user identifier 1315 which may assist in selecting a suitable response. The response controls 1320 may be used to select a response. For example, if a query is a binary choice, the response control 1320 may identify named entities in a request, which may be indicated in a number of response indicators such as the response indicators 1325a, 1325b. Activation of a response indicator may affect information provided in the suggested response indicators 1355a-1355c. For example, activation of the “Obama” response indicator 1325a may cause responses which include “Obama” to be added or removed from the suggested response indicators 1350a-1350c and/or may select responses associated with a demographic, affiliation, etc., associated with the response indicator 1325a. The response indicators 1335a, 1335b may indicate responses which have already been provided for a request. The responder indicators 1330a, 1330b may indicate a responder associated with a response. The Conversation indicators 1340a, 1340b may be used to establish bidirectional communication with a responder associated with the respective response indicators. As illustrated in FIG. 13, the response ‘By 47 to 45 percent, Americans say Obama is a better President than George W. Bush.’ indicated in the response indicator 1335a provided by ‘Nular’ as indicated by the responder indicator 1330a may have already been provided to a user. Possible or suggested responses to a request may be obtained in various ways. For example, a forum, a Twitter® feed, a Facebook® page, etc., which may include relevant information may be indexed. Information of relevant responses may be provided in the suggested response indicators 1355a-1355c. If a responder determines that a response indicated in a response indicator is suitable a responder may activate a response indicator. Content of response indicators may be presented in an order based on a ranking of responses. For example, content of a response, a resource which has produced a response, prior selections of a response, responder actions, and/or statistical data of such items may be used to determine a ranking and/or rating of a response. Activation of a response indicator may allow a responder to edit content of a response indicator using the responder input controls 1360. A response may be submitted by activating the response submission control 1365. While a keypad is used for purposes of illustration, any user input device which is well known in the art may be used to implement the user input control 1365.

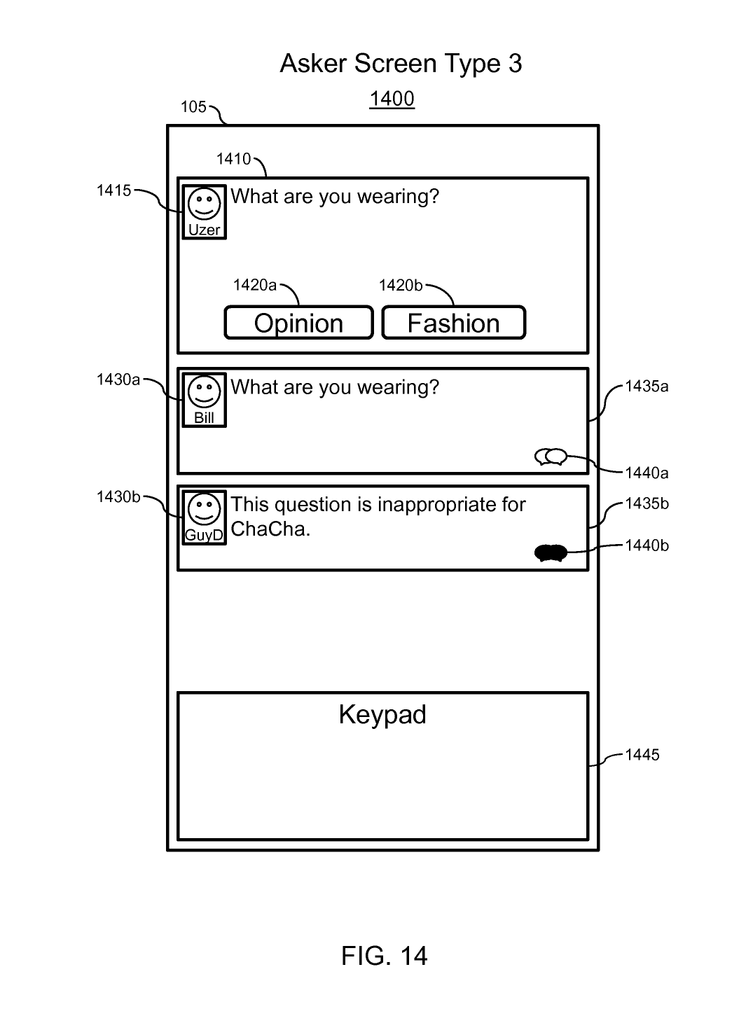

As illustrated in FIG. 14 an exemplary GUI 1400 for submitting and receiving a response to a subjective question is provided. The GUI 1400 may be provided when a request is submitted by a user and/or a response is provided. The GUI 1400 may be provided using a device such as the user system 105 (FIG. 1). A user may receive a notification when a new answer is provided to a request. The GUI 1400 may include a query indicator 1410, a user indicator 1415, category indicators 1420a-1420b, responder indicators 1430a, 1430b, response indicators 1435a, 1435b, conversation indicators 1440a, 1440b and user input controls 1445.

The query indicator 1410 may be used to provide information of a request. The user indicator 1415 may be used to provide information of a user associated with a request. The category indicators 1420a-1420b may be used to provide information of keywords, categories, types, etc. associated with a request, which may be used to select a request, a responder, a resource, etc. The responder indicators 1430a, 1430b may be used to indicate information of a responder associated with a response indicated in the response indicators 1435a, 1435b. The conversation indicators 1440a, 1440b may be used to indicate whether a responder is accepting communications regarding a response. Activation of the conversation indicator 1440a may permit ‘Uzer’ as indicated by the user indicator 1415 to establish a two-way communication with ‘Bill’ as indicated by the responder indicator 1430a. While a keypad is used for purposes of illustration, any user input device which is well known in the art may be used to implement the user input control 1445.

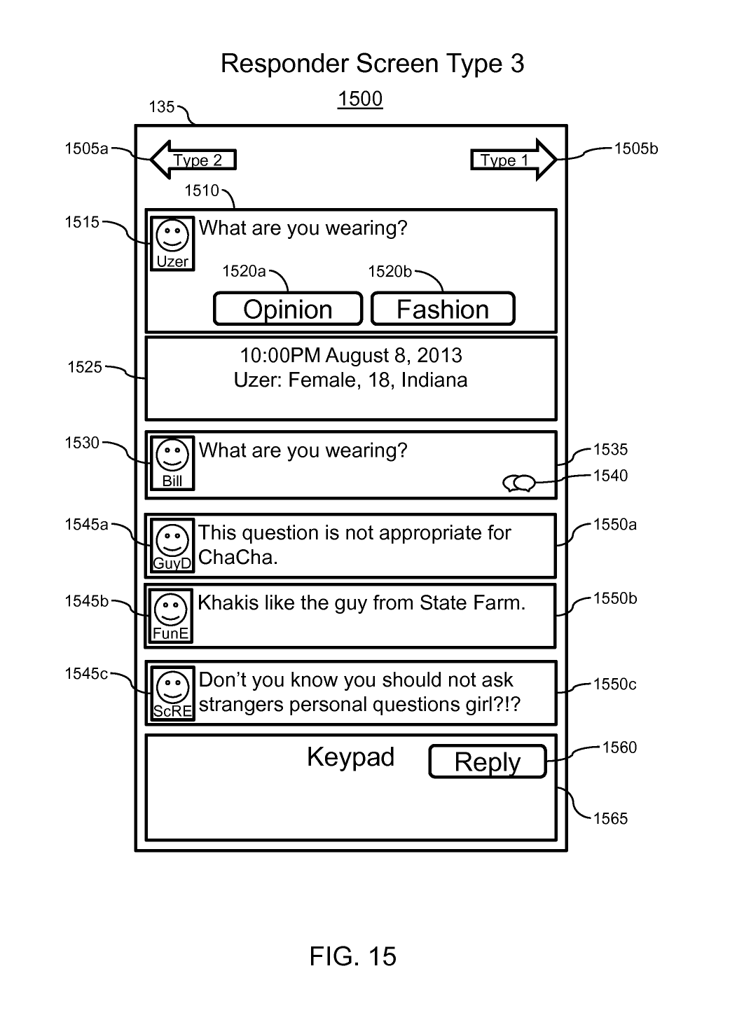

As illustrated in FIG. 15 an exemplary GUI 1500 is provided. The GUI 1500 may be provided to a responder and/or guide for responding to a query. The GUI 1500 may be provided when a request is determined to be conversational in nature. For example, a request for humor, personal information, and/or other information regarding a responder rather than a topic may be classified as conversational. The GUI 1500 may include response type indicators 1505a-1505b, a query indicator 1510, a user indicator 1515, category indicators 1520a, 1520b, a user information indicator 1525, responder indicator 1530, a response indicator 1535, a conversation indicator 1540, responder avatars 1545a-1545c, suggested response indicators 1550a-1550c, a response submission control 1560, and responder input control 1565.

The user interface selectors 1505a, 1505b may be used to select alternate user interfaces which may be more suitable for responding to a request. Activation of the user interface selectors 1505a, 1505b may cause a type assigned to a request to be modified. The query indicator 1510 may be used to provide information of a request, such as the request ‘What are you wearing?’ submitted by ‘Uzer’ as indicated in the user indicator 1515. Information of a user may be provided by the user information indicator 1525. Activation of the user indicator 1515 may cause the user profile indicator 1525 to be presented. The category indicators 1520a, 1520b may indicate a type assigned to a request. A responder may modify a category indicator by activating a category indicator. The response indicator 1535 may indicate that the responder ‘Bill’ as indicated by the responder indicator 1530 has responded to ‘Uzer’ with ‘What are you wearing?’ The conversation indicator 1540 may indicate that responder ‘Bill’ is available for a conversation with ‘Uzer’. Alternate responses which may be selected by the search system 130 (FIG. 1) may be presented in the suggested response indicators 1550a-1550c. A responder may activate a potential response indicator 1550a-1550c, which may determine if a response is sent to a user. Information in the responder avatars 1545a-1545c may be provided to a user if a suggested response associated with a responder avatar is selected. A responder avatar may indicate a classification of response, a source of a response, a responder, etc. If a response such as the response indicated in the suggested response indicator 1550a is selected, a user request may be submitted for review by a system administrator and/or other person. The responder input controls 1565 may be used to edit and/or compose a response. For example, a responder may elect to modify content of a suggested response indicator using the responder input control 1565. The response submission control 1560 may be used to indicate that a response is to be provided. While a keypad is used for purposes of illustration, any user input device which is well known in the art may be used to implement the user input control 1565.

While a limited number of controls have been included in the user interfaces described herein, any number of controls as may be required to operate the embodiments may be employed. Any types of user interface elements which are well known in the art which may be used to implement equivalent functionality may be used within the spirit and scope of the embodiments described herein.

Using the method and systems described herein assistance is provided to a human responder who is responding to a request for subjective information. An enhanced communication between users of a messaging service is provided. If a request is received, the request is classified according to a type of information which is sought by a user. A type may be assigned to a request for subjective information. When a responder receives a query, a user interface and information relevant to the query may be presented in a format adapted based on a most likely type which has been associated with the query. A responder may select a response from a predetermined group of responses. A responder may select a suggested response, edit a suggested response, may create a free-form response, or may find related information.

A user interface may be presented which is intended to respond to a subjective request which is seeking an undeterminable event. A responder may be provided with a list of responses in an order based on previous responses delivered to a user. A request may be directed to an automated system based on historical information of a user. An automated response may be provided based on a type associated with a request. A user may indicate a type associated with a request. Potential responses may be obtained from media content based on a request. Potential responses may be provided to a responder based on content of a request. A responder may filter potential responses based on a keyword, category, location, age, etc.

A suggested response may be provided to a responder based on information associated with a request. Profile information associated with a request such as a profile of a user, a responder, a guide, etc. may be used to select suggested responses to a request, which may be provided to a responder. Actions of a responder may affect suggested questions provided to a responder. A responder may be selected based on a type associated with a request. If a request is determined to be of high importance, the request may be directed to a guide or paid responder instead of a peer responder.

A type may be assigned to a request based on various factors. A type may be assigned based on characteristics of a user such as gender, age, location, personality, affiliation, query and/or response history, etc. A responder may assign a type to a request. A responder may indicate a type associated with a request by selecting a different user interface for responding to a request. A probability that a request is assigned to a type may be affected by actions of a responder and/or a user. A responder may be able to obtain various types of suggested responses. A responder may be provided with profile information of a user based on a type associated with a request. A responder may elect to accept requests associated with a type. A responder may elect to block requests associated with a type. Use of interfaces and systems described herein may enhance user experience and facilitate more effective and efficient communication between users and reduce time and computing power required for such interactions.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various computer-readable media including, a disk, a DVD, an internal storage device (memory such as RAM or ROM) in a computer, etc.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of enhancing communications in a network, comprising:
receiving a request;
classifying an object of the request as subjective information;
assigning a type to the request based on content of the request;
providing, by a processor, information to a recipient of the request based on the type; and
responding to the request based on actions of the recipient.

2. The method of claim 1 comprising:
classifying the object based on an action of a user submitting the request.

3. The method of claim 1 comprising:
classifying the object based on an action of a user submitting the request.

4. The method of claim 1 comprising:
including a ranked list of responses in the information when the content requests personal information of the recipient.

5. The method of claim 1 comprising:
including a randomly ordered list of phrases in the information when the content requests information of a future event.

6. The method of claim 1 comprising:
including a list of phrases obtained from a resource selected based a keyword of the request in the information when the content requests information regarding the keyword.

7. The method of claim 1 comprising:
including indicators of types not assigned to the request in the information; and
providing interfaces associated with the types when the indicators are activated.

8. The method of claim 1 comprising:
assigning the type based on a computation of a probability based on a database of request associated with types; and
modifying the computation of the probability based on an action of the recipient which indicates the type is incorrect.

9. The method of claim 1 comprising:
modifying the type based on requests of a user associated with the request.

10. The method of claim 1 comprising:
preventing a human assistant from receiving the request when the human assistant blocks requests associated with the type.

11. The method of claim 1 comprising:
selecting an automated resource as the recipient based on a ranking of the request.

12. The method of claim 1 comprising:
selecting an automated resource as the recipient based on a ranking of the user; and
selecting the automated resource based on the type.

13. The method of claim 1 comprising:
preventing a human assistant from receiving the request based on demographic information of the human assistant; and
preventing the human assistant form receiving the request based on the type.

14. A computer-readable medium having embodied therein a program for causing a computer to execute operations including optimization of interactions between users in a network, comprising:
receiving a request;
classifying an object of the request as subjective information;
assigning a type to the request based on content of the request;
providing information to a recipient of the request based on the type; and
responding to the request based on actions of the recipient.

15. The computer-readable medium of claim 14 wherein the operation, comprises:
ranking responses indicated in the information based on demographic information of the recipient; and
determining characteristics of a source of the request based on a response of the source to a response chosen by the recipient.

16. The computer-readable medium of claim 14 wherein the operation, comprises:
obtaining responses based on content of the request;
ranking the responses based on a resource which was used to obtain the request; and
modifying a ranking of the resource for the content based on a selection of the recipient.

17. A system for enhancing interaction efficiency between users of a networked communication service, comprising:
a server device comprising memory and a processor receiving a request, classifying an object of the request as subjective information, assigning a type to the request based on content of the request, providing information to a recipient of the request based on the type and responding to the request based on actions of the recipient.

18. The system of claim 17 further comprising:
a user device providing an interface which indicates that the request is subjective and a category assigned to the request based on the content.

19. The system of claim 18 further comprising:
a responder device receiving the request, presenting a user interface based on the type, indicating a ranked list of responses, receiving a selection of a named entity, revising content of the ranked list based on the selection, obtaining a choice of an element of the ranked list, and delivering a response based on the choice; and
the server device providing an indicator of a person other than the responder based on a source of a selected response and providing a connection to a conversation simulation when an automated answer is the selected response.

20. The system of claim 19 further comprising:
a resource device providing responses to the server device when the type matches an interface implemented by the resource device, and delivering the responses based on the type, the content, demographic information associated with the responder device and the user device, and statistics of historical performance of responses associated with the responder device and the demographic information.
